(19) United States
(12) Patent Application Publication
(10) Pub. No.: US 2004/0101816 A1
(43) Pub. Date: May 27, 2004

(54) Laboratory data collection and reporting

(75) Inventors: Meir Gerner, Nirit (IL); Dov Bruker, Ra'anana (IL)

Correspondence Address: DARBY & DARBY P.C., 805 Third Avenue, New York, NY, 10022, US

(73) Assignee: FOURIER SYSTEMS (1989) LTD.

(21) Appl. No.: 10/305,227

(22) Filed: Nov. 26, 2002

(51) Int. Cl. G09B 23/00

(52) U.S. Cl. 434/276

(57) ABSTRACT

A method for recording an experiment performed in an educational environment, including measuring data from the experiment at a plurality of times using a data logger, generating, using the data logger, respective indications of at least some of the times, and generating an audiovisual (A/V) record of the experiment. The method further includes incorporating the respective indications into the A/V record so as to form an annotated A/V record, storing the data and the annotated A/V record, recovering the respective indications of the times and a selected portion of the A/V record from the annotated A/V record, generating respective experimental results from the data responsive to the respective indications of the times, and storing the selected portion of the A/V record and the respective experimental results as an experiment report.

### FIELD OF THE INVENTION

The present invention relates generally to performing a laboratory experiment, and specifically to recording and reporting of the laboratory experiment in an educational environment.

### BACKGROUND OF THE INVENTION

In an educational environment such as a school or college, a laboratory experiment may typically be performed using a data logger. The data logger comprises a central processing unit (CPU) which is coupled to one or more probes measuring parameters of the experiment. Such probes are well-known in the art, and comprise individual devices used to measure parameters such as pH, pressure, temperature, force, electromagnetic radiation intensity, and electric potential. The CPU operates the probes and stores measurements derived therefrom in a memory. The memory may be integral with the data logger, so that the data logger may operate substantially as a stand-alone unit. Alternatively or additionally, the memory may comprise an external memory, such as the memory of a computer, and the data logger is coupled to the computer.

The measurements stored by the data logger may be presented in a variety of ways, for example, as single values of measurements, in a spreadsheet, and/or as a graph. The presentation may be via a display such as a liquid crystal display (LCD) which may be incorporated in the data logger, or the display may be in the computer coupled to the data logger. Furthermore, the displayed measurements may be displayed as substantially “raw” data, or as data which is processed by the data logger or the computer. It will be appreciated that the display may be implemented as the experiment is performed, or at some later time using the data stored in the memory.

A student performing the experiment will normally be expected to present a report of the experiment. The report comprises topics such as an objective of the experiment which may include a theory, an apparatus set-up, steps taken to perform the experiment, results obtained/observations noted, an analysis of the results or observations, and a summary and conclusion. The report is prepared using text and graphics, and may be presented as hard-copy or in the form of a computer file. Sections of the report covering the results obtained, the analysis of the results, and the summary and conclusion will utilize data recorded by the data logger.

Preparing such a report is time consuming for the student, at least in part because of the need to integrate data from the data logger into the report. Furthermore, there is a possibility that some data pertinent to the experiment may not be measured, recorded, or even noted by the student. A more efficient method for reporting the experiment is thus advantageous.

### SUMMARY OF THE INVENTION

It is an object of some aspects of the present invention to provide methods and apparatus for recording a laboratory experiment.

In preferred embodiments of the present invention, a data logger is coupled to one or more probes which respectively make measurements of an experimental set-up. A video camera, which is able to capture both video and audio, is positioned to record the experimental set-up during the course of an experiment performed with the set-up. In addition, the video camera captures actions and observations made by a student performing the experiment. The data logger and the video camera are coupled to a central computer which stores data derived from the data logger. The central computer also stores an audiovisual record, incorporating the student's actions and observations with the experimental set-up, derived from video and audio signals generated by the camera. The data logger is programmed to generate time indications at regular intervals during the course of the experiment and to provide these indications to the computer, which in turns incorporates the time indications in the audiovisual record to form an annotated record.

A dynamic report of the experiment is produced by playing back the annotated audiovisual record, with its incorporated time indications, on a monitor of the computer. The time indications are used to recover data that was stored at times corresponding to the indications, enabling synchronization between the stored data and the audiovisual record. The recovered data is also presented on the monitor, typically as a dynamic graph or spreadsheet. In preparing the report the student most preferably arranges a display on the monitor to most advantageously illustrate results of the experiment and the actions and observations made by the student, by, for example, selecting and editing portions of the audiovisual record. Such editing preferably includes an option for the student to add audiovisual commentary, such as a voice-over, to the audiovisual record. Dynamic experiment reports as described above, including actions and observations made by the student performing the experiment during its course, are an efficient way of producing the experimental report.

After preparing the report, the student is able to present the report to a teacher, as a computer file, for the purposes of assessment. In preferred embodiments of the present invention, the teacher incorporates the assessment into the file so generating an assessed report. It will be appreciated that the assessment may be in the form of text; alternatively or additionally, the assessment may comprise a teacher audiovisual commentary. The teacher then returns the assessed report to the student.

There is therefore provided, according to a preferred embodiment of the present invention, a method for recording an experiment performed in an educational environment, including:

measuring data from the experiment at a plurality of times using a data logger;

generating, using the data logger, respective indications of at least some of the times;

generating an audiovisual (A/V) record of the experiment;

incorporating the respective indications into the A/V record so as to form an annotated A/V record;

storing the data and the annotated A/V record;

recovering the respective indications of the times and a selected portion of the A/V record from the annotated A/V record;

generating respective experimental results from the data responsive to the respective indications of the times; and

storing the selected portion of the A/V record and the respective experimental results as an experiment report.

Preferably, measuring the data includes a student operating the data logger, and generating the A/V record of the experiment includes the student incorporating during the experiment a student A/V commentary into the A/V record responsive to an event occurring in the experiment.

Further preferably, displaying the selected portion of the A/V record includes the student editing the A/V record after conclusion of the experiment and incorporating a subsequent A/V commentary into the A/V record so as to form an edited A/V record. The method preferably also includes assessing the experiment report so as to provide feedback to the student responsive to the report. Preferably, assessing the experiment report includes a supervisor of the student incorporating a supervisor A/V commentary as a report assessment into the experiment report.

Preferably, generating the respective experimental results includes displaying the selected portion of the A/V record and the respective experimental results on an audiovisual monitor.

Preferably, generating the respective experimental results includes incorporating therein data from times intermediate the at least some of the times.

Alternatively or additionally, generating the respective experimental results includes processing the data to produce processed data and generating visual and analytic expressions of the processed data. Preferably, generating the respective experimental results includes editing the A/V record responsive to the processed data so as to form an edited A/V record.

Preferably, recovering the selected portion of the A/V record and generating the respective experimental results from the data include selecting the selected portion of the A/V record to be synchronized with the respective experimental results.

There is further provided, according to a preferred embodiment of the present invention, apparatus for recording a laboratory experiment performed in an educational environment, including:

a data logger, which is adapted to measure data from the experiment at a plurality of times, and to generate respective indications of at least some of the times;

a camera, which is adapted to generate an audiovisual (A/V) record of the experiment; and

a central processing unit (CPU), which is adapted to incorporate the respective indications into the A/V record so as to form an annotated A/V record, to store the annotated A/V record and the data, to recover the respective indications of the times and a selected portion of the A/V record from the annotated A/V record, to generate from the data respective experimental results responsive to the respective indications of the times as an experiment report, and to store the experiment report.

Preferably, the apparatus is operated by a student, and the CPU is adapted to incorporate during the experiment a student A/V commentary into the A/V record responsive to an event occurring in the experiment.

Preferably, the CPU is adapted to incorporate after conclusion of the experiment a subsequent A/V commentary provided by the student into the A/V record so as to form an edited A/V record.

Preferably, the CPU is adapted to receive and store an assessment of the experiment report that provides feedback to the student responsive to the report. Preferably, the assessment is provided by a supervisor of the student, and the CPU is adapted to incorporate a supervisor A/V commentary into the experiment report as the assessment.

Preferably, the apparatus includes an audiovisual monitor which is coupled to the CPU and which is adapted to display the selected portion of the A/V record and the respective experimental results.

Preferably, the CPU is adapted to incorporate into the respective experimental results data from times intermediate the at least some of the times.

Preferably, the CPU is adapted to process the data to produce processed data and to generate visual and analytic expressions of the processed data. Further preferably, the CPU is adapted to edit the A/V record responsive to the processed data so as to form an edited A/V record.

Preferably, the CPU is adapted to select the selected portion of the A/V record to be synchronized with the respective experimental results.

The present invention will be more fully understood from the following detailed description of the preferred embodiments thereof, taken together with the drawings, in which:

### BRIEF DESCRIPTION OF THE DRAWINGS

FIG. 1 is a schematic illustration of an experimental set-up, according to a preferred embodiment of the present invention; and

FIG. 2 is a flowchart showing steps performed in recording the experimental set-up of FIG. 1, according to a preferred embodiment of the present invention.

### DETAILED DESCRIPTION OF PREFERRED EMBODIMENTS

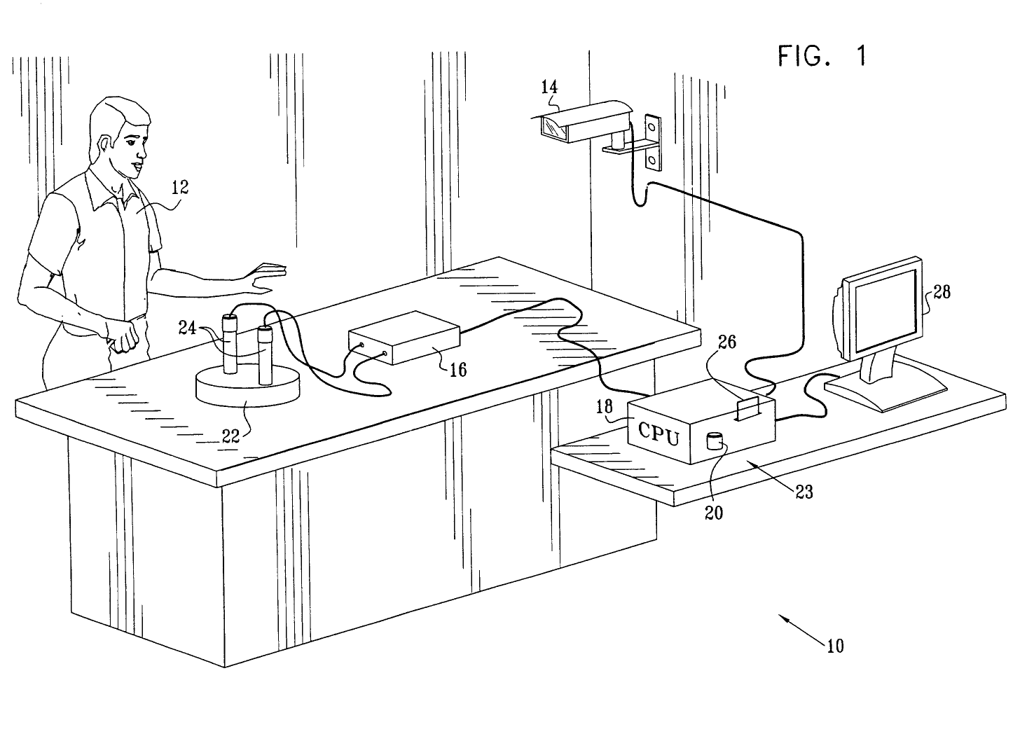

Reference is now made to FIG. 1, which is a schematic illustration of an experimental set-up 10, according to a preferred embodiment of the present invention. Set-up 10 is most preferably arranged by a student 12 who performs an experiment using the set-up. Alternatively, the set-up is arranged by a person other than the student, such as a teacher or a professor of the student. Set-up 10 comprises a data logger 16 which is coupled to one or more probes 24 operating in experimental apparatus 22. A suitable data logger comprises the Multilog data logger produced by Fourier Systems Ltd., of Petah Tiqva, Israel, although any other data logger may be used. Probes 24 monitor parameters of the experiment being performed, and are chosen according to the experiment. A relatively large number of such probes are known in the art, each probe being able to make individual measurements of physical parameters such as pH, pressure, temperature, force, electromagnetic radiation intensity, and electric potential.

Data logger 16 is coupled to a central processing unit (CPU) 18, which most preferably comprises an industry standard personal computer, and which comprises a non-volatile memory 20 wherein data generated by the data logger and probes 24 is stored.

A video camera 14, which is able to capture both audio and video, is also coupled to CPU 18. The camera is arranged to capture images of set-up 10 as the experiment is performed by student 12. Most preferably, before the experiment is performed, camera 14 is aligned with set-up 10 using a monitor 28 attached to CPU 18. Signals from camera 14 are processed through software 23, resident in memory 20, before being stored in the memory as an audiovisual record of the experiment. Software 23 comprises any software which is able to encode signals from camera 14 into a form suitable for storage in memory 20. Software 23 is also able to incorporate a script command into individual frames of the audiovisual record generated by the camera, the script command, inter alia, enabling the respective raw individual frame associated with the command to be manipulated after storage. Preferably, software 23 comprises Windows Media™ Encoder version 7.1 or similar, produced by Microsoft Corporation, of Redmond, Wash. Software 23 is preferably at least partly implemented using hardware such as an image capture device 26 incorporated in processor 18. Image capture device 26 or software 23 compresses signals received from camera 14 so that compressed data may be stored in memory 20; the device or the software also decompresses the compressed data when the signals are played back.

In addition to sampling and recording data from set-up 10, data logger 16 is implemented to provide sequential script commands to software 23. The sequential script commands are provided at regular time intervals, preferably every 100 Ms, to the software, which incorporates the commands with the compressed audiovisual signals stored in memory 20. Each script command acts as a time indication, or marker, of the signal with which it is stored.

During the course of the experiment performed by student 12, the student makes verbal comments about observations noted by the student concerning performance of the experiment. The verbal comments may also include a description or explanation of an action taken by the student, or an event occurring in the experiment, or any other factor which the student considers relevant to the experiment For example, in a titration experiment using an indicator phenolphthalein and a pH probe as one of probes 24, student 12 may comment that even though the pH is greater than 7, the color of the indicator has not changed; or in an experiment to show that force on a spring is proportional to displacement of the spring, using a force probe and a position probe as probes 24, the student may comment that no further force may be exerted on the spring because the force probe would exceed a design limit.

In addition to making verbal comments that are recorded, student 12 may also introduce visual material into the audiovisual record of the experiment. For example, the student may point to a feature of the experimental set-up which has a particular significance (and preferably add a verbal comment explaining the significance). Furthermore, student 12 may adjust camera 12 to record the feature in more detail. For example, in an experiment to demonstrate diffraction of a laser beam by a single slit, probes 24 comprise a radiation probe and a position probe. The diffraction may be measured without visual observation of a diffraction pattern. In order to explain what is happening in the experiment, student 12 may introduce a screen at a position where the measurements are being made, so that the diffraction pattern may be visually recorded by camera 14. Student 12 may also adjust the camera to focus more specifically on the screen and the diffraction pattern while the screen is in place, most preferably returning the camera to its original position after removal of the screen.

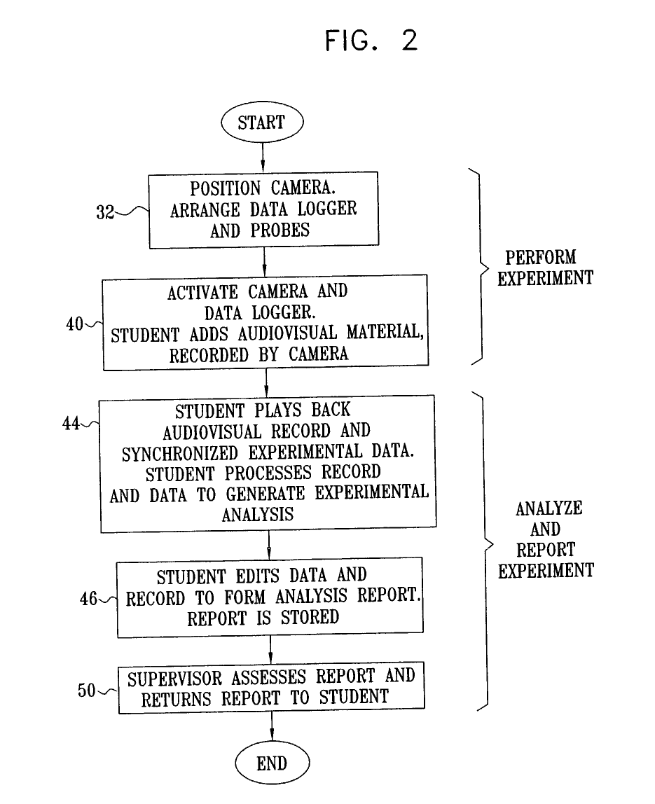

FIG. 2 is a flowchart showing steps performed in recording experimental set-up 10, according to a preferred embodiment of the present invention. In a set-up step 32, camera 14 is positioned to record set-up 10, and data logger 16 and probes 24 are arranged to record data generated by the experiment.

In a perform-experiment step 40, the camera is activated and provides, via software 23, compressed audiovisual input to processor 18, the audiovisual input being stored in memory 20 as an audiovisual record of the experiment being performed, as described above with reference to FIG. 1. Data logger 16 is also activated, and provides experimental measured data to the processor, the data also being stored in memory 20. The data logger generates sequential script commands at preset command intervals, preferably equal to 100 ms although any other convenient interval may be chosen, and the script commands are stored, via software 23, as sequential numbers with the audiovisual record to form an annotated audiovisual record. The sequential script commands act as time indications, i.e., time markers, of the experiment, and are used, as described below, for synchronizing the audiovisual record with the experimental measured data. During step 40, student 12 adds audiovisual material, as described above with reference to FIG. 1, which is recorded and stored by camera 14 in memory 20, and which is incorporated into the annotated audiovisual record. Step 40 continues for the duration of the experiment.

In a generate-analysis step 44, which is implemented after the conclusion of the experiment, student 12 plays back the audiovisual record from memory 20 as a display on monitor 28. Processor 18 uses the sequential numbers stored as time indications in the perform-experiment step to recall results of the experiment which have been stored at the times corresponding to the numbers. The sequential numbers thus enable the processor to provide “snapshots” of the experimental results which are synchronized by the time indications with the audiovisual record playback, and student 12 organizes and presents the snapshots, together with the audiovisual record playback, to show the outcome generated by the experiment. It will be appreciated that each snapshot may comprise some or all of the results recorded by data logger 16 up to and including the time of the snapshot. For example, the data logger may generate 500 samples/s while snapshots are being taken every 100 ms, i.e., there are approximately 50 samples between snapshots. Student 12 is able to display the results in the form of a graph, and each snapshot graph preferably includes all 50 results since the previous snapshot.

In implementing step 44, student 12 is able to process raw data from data logger 16 after it has been stored in memory 20. Software 23 most preferably includes processing algorithms which enable the student to generate visual and analytic expressions of the processed data. In addition to processing the raw data, student 12 can edit the corresponding audiovisual record. For example, the student may incorporate a voice-over into the record to point out or describe an event of interest that occurred during the experiment, i.e., during implementation of step 40; alternatively or additionally the student may incorporate a rationale for implementing a specific algorithm on the raw data.

In an analysis-report step 46, that is implemented after the conclusion of step 44, the student may edit all data (raw and processed) together with the synchronized audiovisual records into an organized Experiment Analysis Report. For example student 12 may delete or reduce in size a part of the audiovisual record having lower relevance to the experiment. The student may implement other forms of editing, as are well known in the art. All such forms of editing are assumed to be within the scope of the present invention. By editing the raw and processed data and the raw audiovisual record, student 12 generates an Experiment Analysis Report of the experiment.

In step 46 student 12 also stores the analysis report, which is most preferably subsequently provided by the student to the student's teacher or professor, herein termed the experiment supervisor, for assessment.

In an assessment step 50, the supervisor assesses the report. The assessment is most preferably provided to student 12 by the supervisor incorporating an audiovisual assessment commentary into the report, to generate an assessed report. Alternatively or additionally, the assessed report includes text commentary and/or a grade from the supervisor.

It will be appreciated that enabling a student to prepare a dynamic report of an experiment, as described above with reference to FIGS. 1 and 2, significantly improves the ability of the student to efficiently record the experiment. The student may add audiovisual commentary to the experiment record during the course of the experiment. The student may also add further commentary to the recorded data after completion of the experiment. For example, the student may observe in generate-analysis step 44 an experimental event that was recorded by the camera, but was not noticed when the experiment was performed. The student may then add, in step 44, audiovisual commentary concerning the event.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for recording an experiment performed in an educational environment, comprising:
measuring data from the experiment at a plurality of times using a data logger;
generating, using the data logger, respective indications of at least some of the times;
generating an audiovisual (A/V) record of the experiment;
incorporating the respective indications into the A/V record so as to form an annotated A/V record;
storing the data and the annotated A/V record;
recovering the respective indications of the times and a selected portion of the A/V record from the annotated A/V record;
generating respective experimental results from the data responsive to the respective indications of the times; and
storing the selected portion of the A/V record and the respective experimental results as an experiment report.

2. A method according to claim 1, wherein measuring the data comprises a student operating the data logger, and wherein generating the A/V record of the experiment comprises the student incorporating during the experiment a student A/V commentary into the A/V record responsive to an event occurring in the experiment.

3. A method according to claim 2, wherein displaying the selected portion of the A/V record comprises the student editing the A/V record after conclusion of the experiment and incorporating a subsequent A/V commentary into the A/V record so as to form an edited A/V record.

4. A method according to claim 2, and comprising assessing the experiment report so as to provide feedback to the student responsive to the report.

5. A method according to claim 4, wherein assessing the experiment report comprises a supervisor of the student incorporating a supervisor A/V commentary as a report assessment into the experiment report.

6. A method according to claim 1, wherein generating the respective experimental results comprises displaying the selected portion of the A/V record and the respective experimental results on an audiovisual monitor.

7. A method according to claim 1, wherein generating the respective experimental results comprises incorporating therein data from times intermediate the at least some of the times.

8. A method according to claim 1, wherein generating the respective experimental results comprises processing the data to produce processed data and generating visual and analytic expressions of the processed data.

9. A method according to claim 8, wherein generating the respective experimental results comprises editing the A/V record responsive to the processed data so as to form an edited A/V record.

10. A method according to claim 1, wherein recovering the selected portion of the A/V record and generating the respective experimental results from the data comprise selecting the selected portion of the A/V record to be synchronized with the respective experimental results.

11. Apparatus for recording a laboratory experiment performed in an educational environment, comprising:
a data logger, which is adapted to measure data from the experiment at a plurality of times, and to generate respective indications of at least some of the times;
a camera, which is adapted to generate an audiovisual (A/V) record of the experiment; and
a central processing unit (CPU), which is adapted to incorporate the respective indications into the A/V record so as to form an annotated A/V record, to store the annotated A/V record and the data, to recover the respective indications of the times and a selected portion of the A/V record from the annotated A/V record, to generate from the data respective experimental results responsive to the respective indications of the times as an experiment report, and to store the experiment report.

12. Apparatus according to claim 11, wherein the apparatus is operated by a student, and wherein the CPU is adapted to incorporate during the experiment a student A/V commentary into the A/V record responsive to an event occurring in the experiment.

13. Apparatus according to claim 12, wherein the CPU is adapted to incorporate after conclusion of the experiment a subsequent A/V commentary provided by the student into the A/V record so as to form an edited A/V record.

14. Apparatus according to claim 12, wherein the CPU is adapted to receive and store an assessment of the experiment report that provides feedback to the student responsive to the report.

15. Apparatus according to claim 14, wherein the assessment is provided by a supervisor of the student, and wherein the CPU is adapted to incorporate a supervisor A/V commentary into the experiment report as the assessment.

16. Apparatus according to claim 11, and comprising an audiovisual monitor which is coupled to the CPU and which is adapted to display the selected portion of the A/V record and the respective experimental results.

17. Apparatus according to claim 11, wherein the CPU is adapted to incorporate into the respective experimental results data from times intermediate the at least some of the times.

18. Apparatus according to claim 11, and wherein the CPU is adapted to process the data to produce processed data and to generate visual and analytic expressions of the processed data.

19. Apparatus according to claim 18, and wherein the CPU is adapted to edit the A/V record responsive to the processed data so as to form an edited A/V record.

20. A method according to claim 11, and wherein the CPU is adapted to select the selected portion of the A/V record to be synchronized with the respective experimental results.
